(19) United States
(12) Patent Application Publication
(10) Pub. No.: US 2011/0222752 A1
(43) Pub. Date: Sep. 15, 2011

(54) MICROCALCIFICATION ENHANCEMENT FROM DIGITAL MAMMOGRAMS

(75) Inventors: Heidi Zhang, Los Gatos, CA (US); Patrick Heffernan, Los Gatos, CA (US)

(73) Assignee: Three Palm Software, Los Gatos, CA (US)

(21) Appl. No.: 12/099,156

(22) Filed: Apr. 8, 2008

Related U.S. Application Data
(63) Continuation of application No. US60/926421, filed on Apr. 27, 2007.

(51) Int. Cl. G06K 9/00

(52) U.S. Cl. 382/132

(57) ABSTRACT

The present invention provides a method for enhancing microcalcifications for computer-aided lesion detection, review and diagnosis. The method includes two steps: partitioning of the breast tissue area and filtering with a convolution kernel. The partitioning process delineates: breast glandular tissue area; fat tissue sub-area and dense tissue sub-area. The 2D or 3D convolution kernels are designed to highlight small spot regions of rapid intensity changes on 2D mammograms or 3D tomosynthesis mammography images. The size of such a kernel is calculated based on the resolution of the mammographic images that are produced from each manufacturer's digital radiography device.

### CROSS-REFERENCE TO RELATED APPLICATIONS

### U.S. Patents Documents

U.S. Pat. No. 5,365,429 January 1993 “Computer detection of microcalcifications in mammograms”

U.S. Pat. No. 6,075,878 June 2000 “Method for determining an optimally weighted wavelet transform based on supervised training for detection of microcalcifications in digital mammograms”

U.S. Pat. No. 6,137,898 November 1998 “Gabor filtering for improved microcalcification detection in digital mammograms”

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

The present invention relates generally to the field of medical imaging analysis. Particularly, the present invention relates to a method and system for enhancement of microcalcifications from digital mammography images in conjunction with computer-aided detection, review and diagnosis (CAD) for mammography CAD server and digital mammography workstation.

The U.S. patent Classification Definitions: 382/254 (class 382, Image Analysis, subclass 254 Image Enhancement or Restoration); 382/173 (class 382, Image Analysis, subclass 173 Image Segmentation).

The aim of the enhancement is to highlight small sized spot shapes, where spot borders present rapid intensity changes, which are often indicative of microcalcifications. Existing enhancement methods for microcalcification detection from digital mammograms are usually based on the first or second spatial derivatives (Sobel, Laplacian, Canny algorithms), or a wavelet transform.

The wavelet transform (including Gabor filtering) involves combinations of a number of wavelet filtered images at a number of orientations. This is computationally expensive. The limited number of orientations also may not well characterize the complex edge shape of the microcalcifications. The derivative methods are, by nature, affected by noise. Therefore a kernel convolution (with Gaussian mask, such as LoG) typically is used to pre-filter the noise and so help to detect the edges with derivative operators. However, selecting an optimal kernel to produce the best result in order to enhance true spots and to keep their true shape and size is more art than science. In addition, the inherent inhomogeneity of breast tissue as seen in mammography images often interferes with this enhancement process, and so decreases the segmentation quality.

### BRIEF SUMMARY OF THE INVENTION

To solve the previously existing problems identified in the BACKGROUND OF THE INVENTION, this invention processes digital mammograms by first partitioning and mapping the image into three homogeneous areas: the breast glandular tissue area, the fat tissue area and the dense tissue area (including pectoral muscle). So a single enhancement filter can be used for each of the density homogeneous areas. In each area, an optimal two-dimensional or three-dimensional convolution filter kernel is invented to enhance microcalcifications from digital mammograms. Instead of normalizing the image spatial resolution, which could cause loss of detailed microcalcification information, the size of the kernel is dynamically calculated to adapt to images with different resolution.

### BRIEF DESCRIPTION OF THE SEVERAL VIEWS OF THE DRAWING

Digital mammograms are partitioned into three homogeneous areas: the breast glandular tissue area, the fat tissue area and the dense tissue area (including pectoral muscle). So a single enhancement filter can be used for each of the tissue density areas. See FIG. 2 for details.

In each area, an optimal two-dimensional or three-dimensional convolution filter kernel is invented to enhance microcalcifications from digital mammograms. See FIG. 3 and FIG. 4 for details.

Mammogram images may have different resolutions from different manufacturers. So the number of pixels to form the same sized microcalcification is different for images from different sources. Instead of normalizing the image spatial resolution, which could cause loss of detailed microcalcification information, the size of the kernel is dynamically calculated to adapt to images with different resolution. See FIG. 5 for details.

FIG. 1 shows how the proposed method from this invention is used in a computer-aided detection and review system.

### DETAILED DESCRIPTION OF THE INVENTION

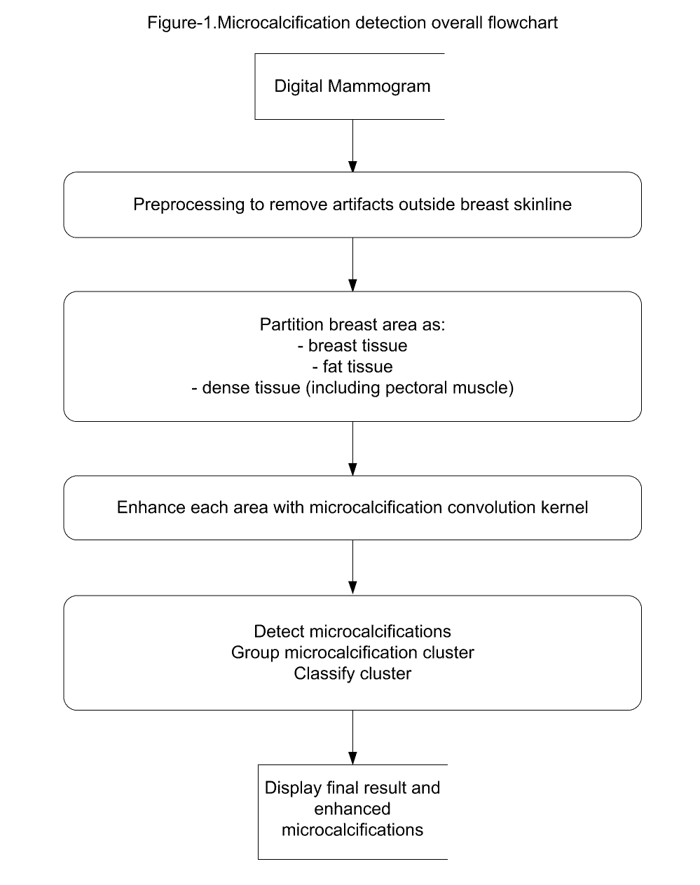

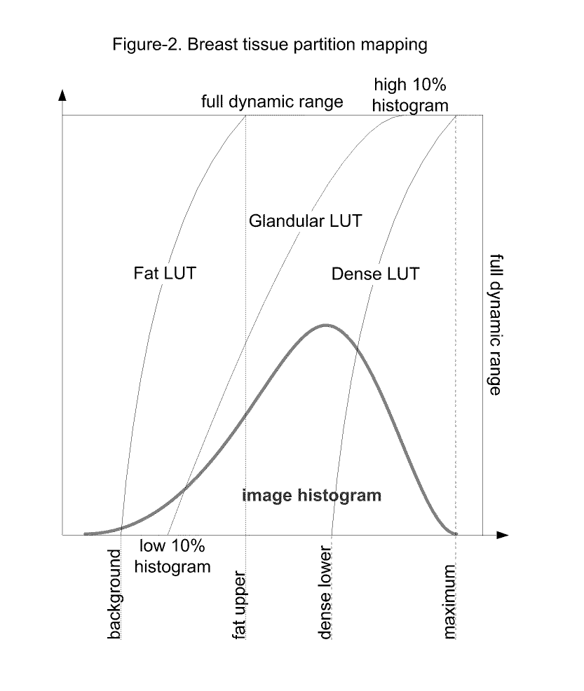

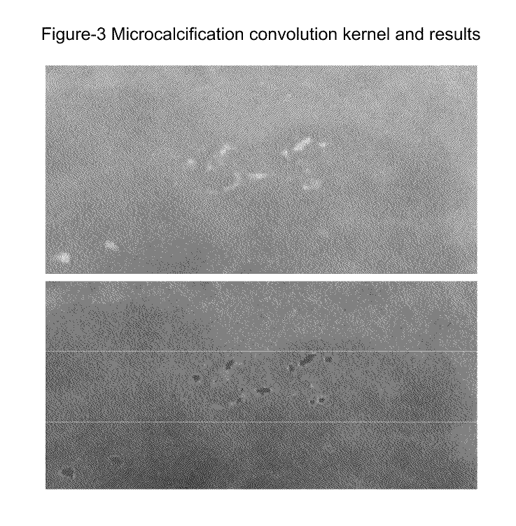

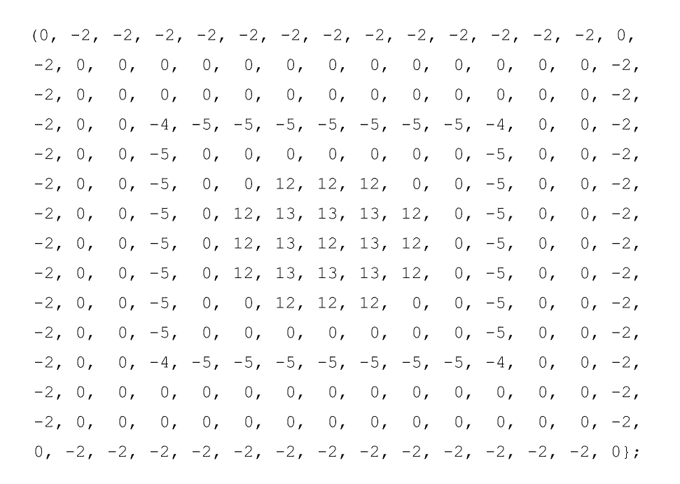

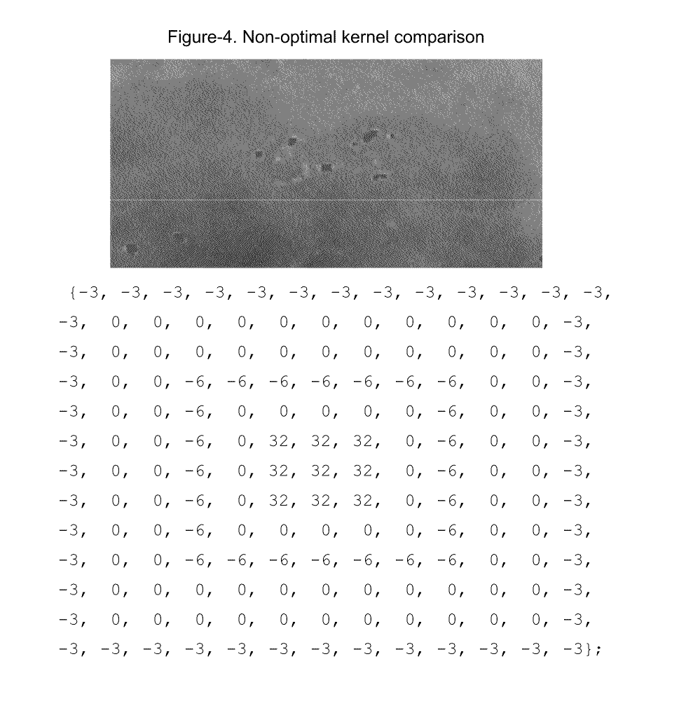

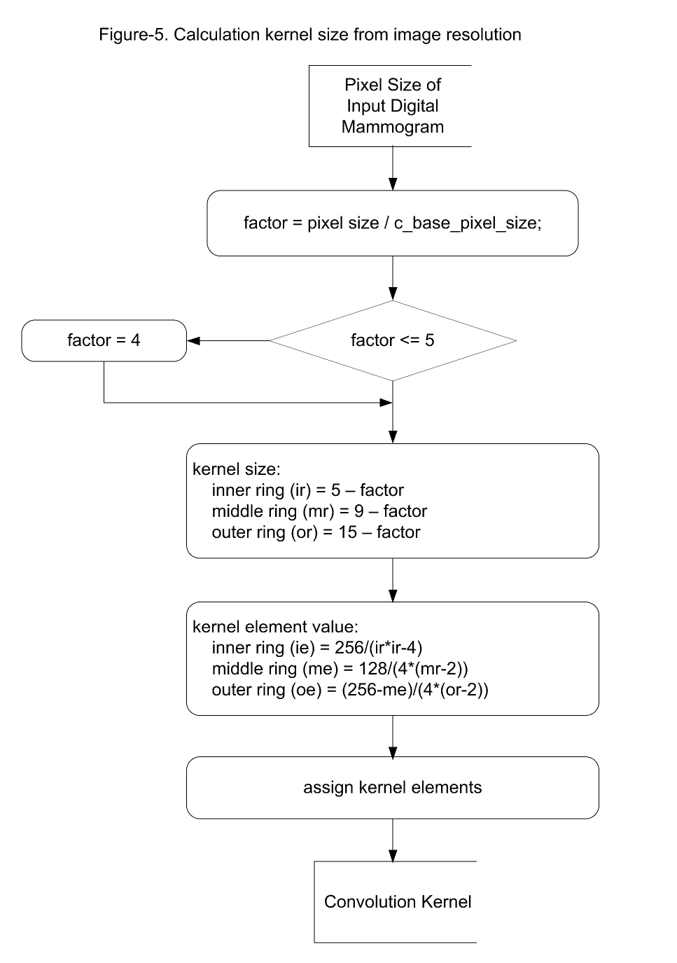

Early detection of breast cancer is the goal of mammography screening. With the rapid transition from film to digital acquisition and reading, more radiologists can benefit from advanced image processing and computational intelligence techniques when they are applied to this task. The method and system in this invention will be used as either a “second read” or a “concurrent read” tool for digital mammography screening—ultimately, will be used as a “communicative read” tool for radiologists. In this task, enhancement of microcalcifications is the initial step for a CAD server or a diagnosis review workstation. As shown in FIG. 1, the microcalcification detection system includes steps of preprocessing to remove artifacts outside breast tissue area; partitioning the breast area as breast glandular tissue area, fat tissue area and dense tissue area which each area is in a sub-range of full pixel dynamic range; remapping and enhancing each area using a filter with a convolution kernel; finally detecting microcalcifications using the enhanced images.

The idea to partition the digital mammograms into three areas is to make each area a homogeneous area: the breast glandular tissue area, the fat tissue area and the dense tissue area (including pectoral muscle). So a single enhancement filter can be used for each of the tissue density areas. In FIG. 2, a histogram of a mammogram image is calculated from image pixels to determine the mapping parameters for each area. For example, the fat area is defined between air background pixel value and an upper fat level; say around ⅓ of full dynamic range; or dense area is defined between a lower dense level and maximum pixel value; or glandular area is defined between 10% low histogram level and 10% high histogram level. Therefore each area range is mapped to full dynamic pixel range using a lookup table.

Mammogram images may have different resolutions from different manufacturers. So the number of pixels to form the same sized microcalcification is different for images from different sources. Instead of normalizing the image spatial resolution, which could cause loss of detailed microcalcification information, the size of the kernel is dynamically calculated to adapt to images with different resolution. See FIG. 5 for details.

In each area, an optimal two-dimensional or three-dimensional convolution filter kernel is invented to enhance microcalcifications from digital mammograms. The FIG. 3 shows an example that the convolution kernel size and elements are calculated based on pixel size, so produces optimal enhancement (following segmentation) result. The FIG. 4 provides a comparison with a fixed kernel where the “square” looking of the segmentation from the non-optimal enhancement.

1. A method to enhance microcalcifications from digital mammography images, which comprises of:
preprocessing to remove artifacts outside breast skinline;
partitioning breast area as: breast glandular tissue, fat tissue and dense tissue (or pectoral muscle);
generating filter using the kernel size based on image resolution;
filtering image to produce enhanced image.

2. The method of claim 1, wherein the partition of the breast areas, comprises steps of:
measuring background level of the pixel value;
defining fat upper level of the pixel value;
generating a lookup table to map the pixel values between the background value and the fat upper value to full dynamic range of the pixel values, so to obtain the fat tissue area;
define the lower dense level of the pixel value
measuring maximum pixel value of the mammography image
generating a lookup table to map the pixel values between the lower dense value and the maximum value to full dynamic range of the pixel values, so to obtain the dense tissue area;
measuring minimum pixel value of the mammography image
generate a lookup table to map the pixel values between (minimum +delta) and (maximum−delta) to full dynamic range of the pixel values, so to obtain the glandular tissue area. The delta value is determined by image histogram.

3. The method of claim 1, wherein the kernel size and the kernel elements are calculated based on image resolution, comprises steps of:
calculating factor=pixel size/base pixel size, and set the factor to 4 if its calculated value smaller than 4;
calculating the inner ring size=5−factor; the middle ring size=9−factor; and outer ring size=15−factor;
calculating the inner ring kernel element=256/[(inner ring size)*(inner ring size)−4]; the middle ring kernel element=128/[4*(middle ring size−2)]; the outer ring kernel element=(256−outer ring size)/[4*(outer ring size−2)].
